(19) United States
(12) Patent Application Publication
(10) Pub. No.: US 2022/0056609 A1
(43) Pub. Date: Feb. 24, 2022

(54) POROUS MATERIALS COMPRISING METAL OXIDES AND THE USE THEREOF

(71) Applicant: Aloxitec Pty Ltd, Lindfield, NSW (AU)

(72) Inventor: Jinghua FANG, Ultimo, New South Wales (AU)

(21) Appl. No.: 17/416,377

(22) PCT Filed: Dec. 18, 2019
(86) PCT No.: PCT/AU2019/051395

§ 371 Date: Jun. 18, 2021

(30) Foreign Application Priority Data
Dec. 19, 2018 (AU) 2018904833

(51) Int. Cl. C25D 11/04; A23B 7/157; A23B 7/159; C25D 21/12; C25D 11/34

(52) U.S. Cl. CPC C25D 11/045; A23B 7/157; C25D 11/34; C25D 21/12; A23B 7/159

(57) ABSTRACT

A material, such as a flexible sheet, including a metal or metal alloy, wherein the metal or metal alloy has at least one porous metal oxide layer thereon. In some examples, the at least one metal oxide layer has a three-dimensional disordered network of channels in which the pores have non-constant diameters. Methods of preparing the materials are also disclosed.

### FIELD OF THE INVENTION

The present invention relates generally to the field of materials science. More particularly, the invention relates to porous materials comprising metals and metal oxides and to the preparation and use thereof.

### BACKGROUND OF THE INVENTION

Any discussion of the prior art throughout this specification should in no way be considered as an admission that such prior art is widely known or forms part of the common general knowledge in the field.

Porous materials such as anodic aluminium oxide (AAO) are self organised materials with honeycomb-like structures formed by high density arrays of uniform and parallel pores. Porous AAO is formed by electrochemical oxidation (anodization) of aluminum in acid electrolytes. By utilising a new anodization process the present inventor has prepared improved metal-based materials with porous oxide layers that find use in a range of different fields, particularly in the area of fruit preservation.

### SUMMARY OF THE INVENTION

In a first aspect the present invention provides a material comprising a metal or metal alloy, wherein the metal or metal alloy has at least one porous metal oxide layer thereon.

The metal may be aluminium, copper, iron, zinc, manganese, palladium or titanium. In one embodiment the metal is aluminium.

The metal alloy may be an aluminium alloy or a zinc alloy. In one embodiment the alloy is an aluminium alloy.

The aluminium alloy may comprise, or consist of, Al and one or more of copper, iron, zinc, manganese, palladium, silicon or titanium.

The aluminium alloy may comprise at least 90%, or at least 95%, or at least 96%, or at least 97%, or at least 98%, or at least 99% Al by weight.

In one embodiment the metal alloy is aluminium foil.

The material may have a thickness of about 1 micron to about 1 mm.

The metal oxide layer(s) may have a thickness between about 300 nm to 1 mm.

The metal or metal alloy may have a thickness between about 100 nm to about 50 microns.

The metal oxide layer(s) may have a three-dimensional disordered network of channels in which pores have non-constant diameters.

The pores may have non-constant diameters ranging from about 1.5 nm to about 250 nm, or from about 1.5 nm to about 200 nm.

The metal oxide layer(s) may have non-constant pore volumes ranging from about 200 cm³/g to about 600 cm³/g.

The metal oxide layer(s) may have a surface area between about 20 m²/g and about 50 m²/g.

The material may be flexible.

The material may be in the form of a sheet.

The metal or metal alloy may have a metal oxide layer on each side.

The material may be attached to a base structure.

The base structure may be wood, glass, quartz, silicon, water-proof paper, plastic or cloth.

In one embodiment of the first aspect the present invention provides a material comprising a metal or metal alloy, the metal or metal alloy having a porous metal oxide layer on each side, wherein the metal oxide layers have a three-dimensional disordered network of channels in which pores have non-constant diameters.

In another embodiment of the first aspect the present invention provides a material comprising an aluminium alloy having a porous oxide layer on each side, wherein the oxide layers have a three-dimensional disordered network of channels in which pores have non-constant diameters ranging from about 1.5 nm to about 250 nm.

In another embodiment of the first aspect the present invention provides a material comprising an aluminium alloy having a porous oxide layer on each side, wherein the oxide layers have a three-dimensional disordered network of channels in which pores have non-constant diameters ranging from about 1.5 nm to about 250 nm, and wherein the metal oxide layers have a surface area greater than about 20 m²/g.

In another embodiment of the first aspect the present invention provides a material comprising an aluminium alloy having a porous oxide layer on each side, wherein the oxide layers have a three-dimensional disordered network of channels in which pores have non-constant diameters ranging from about 1.5 nm to about 250 nm, and wherein the metal oxide layers have a surface area between about 20 m²/g and about 40 m²/g.

In another embodiment of the first aspect the present invention provides a flexible sheet material comprising an aluminium alloy having a porous oxide layer on each side, wherein the oxide layers have a three-dimensional disordered network of channels in which pores have non-constant diameters ranging from about 1.5 nm to about 250 nm, and wherein the metal oxide layers have a surface area between about 20 m²/g and about 40 m²/g.

In another embodiment of the first aspect the present invention provides a flexible sheet material comprising an aluminium alloy having a porous oxide layer on each side, wherein the oxide layers have a three-dimensional disordered network of channels in which pores have non-constant diameters ranging from about 1.5 nm to about 250 nm, and wherein the metal oxide layers have a surface area between about 20 m²/g and about 40 m²/g, and wherein the aluminium alloy has a thickness between about 3 and 10 microns.

In a second aspect the present invention provides a method for preparing a material as defined in the first aspect comprising anodization of the metal or metal alloy in the presence of an electrolyte, wherein the voltage is varied throughout the anodization.

The voltage may be varied throughout the anodization between about 0 V and about 400 V, or between about 0 V and about 200 V, or between about 0 V and about 180 V, or between about 0 V and about 140 V.

The voltage may be varied throughout the anodization by first increasing the voltage linearly, and then applying the voltage in a series of pulses.

Increasing the voltage linearly may involve increasing the voltage at a rate between about 0.05 V/s and about 0.3 V/s, or at a rate between about 0.1 V/s and about 0.2 V/s.

Applying the voltage in a series of pulses may involve repeatedly switching the voltage between a voltage between 100 V and 200 V and 0 V each second.

The voltage may be linearly increased for a period of time between about 10 minutes and about 30 minutes, or between about 10 minutes and about 20 minutes.

The voltage may be linearly increased from 0 V.

The voltage may be linearly increased from 0 V up to a voltage between 100 V and 200 V, or up to a voltage between 120 V and 180 V, or up to a voltage between 130 V and 150 V, or up to about 140 V.

The voltage may be applied in a series of pulses for a period of time between about 30 minutes and 150 minutes, or for a period of time between about 50 minutes and 150 minutes, a period of time between about 90 minutes and about 150 minutes, or for a period of time between about 120 minutes and 150 minutes.

The electrolyte may be phosphoric acid.

The anodization may be performed at a temperature between about 0° C. and about 10° C., or at a temperature of about 5° C.

In a third aspect the present invention provides use of the material of the first aspect for adsorbing one or more gases.

The one or more gases may be ethylene, carbon dioxide and/or oxygen.

In a fourth aspect the present invention provides a method for preserving a product comprising placing the material of the first aspect in the vicinity of the product.

The method may comprise placing the product in a container together with the material.

The method may comprise placing the product in a container together with the material and sealing the container.

The container may be flushed with an inert gas prior to sealing.

The method may comprise wrapping the product with the material.

The product may be a perishable product.

The perishable product may be fruit or vegetables.

The fruit may be bananas, apples or cherries.

In a fifth aspect the present invention provides a method for slowing the ripening of a fruit product comprising placing the material of the first aspect in the vicinity of the product.

The method may comprise placing the fruit product in a container together with the material.

The method may comprise placing the fruit product in a container together with the material and sealing the container.

The container may be flushed with an inert gas prior to sealing.

The method may comprise wrapping the fruit product with the material.

The fruit product may be bananas, apples or cherries.

In a sixth aspect the present invention provides use of a material of the first aspect for preserving a product.

The product may be as described in the fourth aspect.

In a seventh aspect the present invention provides use of the material of the first aspect for slowing the ripening of a fruit product.

In an eighth aspect the present invention provides a method for purifying water comprising contacting the water with a material of the first aspect.

In a ninth aspect the present invention provides a material when obtained by the method of the second aspect.

### Definitions

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps. Thus, in the context of this specification, the term “comprising” means “including principally, but not necessarily solely”.

In the context of this specification the terms “a” and “an” are used herein to refer to one or to more than one (i.e to at least one) of the grammatical object of the article. By way of example, “an element” means one element or more than one element.

The term “about” is understood to refer to a range of numbers that a person of skill in the art would consider equivalent to the recited value in the context of achieving the same function or result.

### BRIEF DESCRIPTION OF DRAWINGS

Embodiments of the invention will now be described by way of example only with reference to the accompanying drawings, in which:

FIG. 1: Time dependence of voltage in connection with the preparation of a material in accordance with one embodiment of the invention.

FIG. 2: Nitrogen absorption and pore volume plot of a material prepared in accordance with one embodiment of the invention.

FIG. 3: A material prepared in accordance with one embodiment of the invention in which: (a) is a photo of the material sample; (b) is a schematic of the structure of the material and (c) and (d) are SEM images showing a top and side views respectively. It is seen that the pores are disordered and have differing pore sizes.

FIG. 4: Energy-dispersive X-ray spectroscopy (EDS) measurement and elemental mapping of an aluminium foil used to prepare a material in accordance with one embodiment of the invention.

FIG. 5: EDS measurement and elemental mapping of a material in accordance with one embodiment of the invention prepared from the aluminium foil.

FIG. 6: XRD spectra of a material prepared in accordance with one embodiment of the invention following calcination at 1400° C.

FIG. 7: Appearance of bananas from day 1 to day 40 using different preservation methods. (a) shows the bunch of bananas prior to commencement of the preservation tests. (b) shows the state of the bananas after 10 days of preservation, wherein the left hand side is banana #1, the middle is banana #2 and the right hand side is banana #3. (c) shows the state of bananas #2 and #3 after 40 days of preservation, wherein banana #2 is on the left and banana #3 is on the right.

FIG. 8: Appearance of bananas #2 and #3 at day 48. Banana #2 is on the left and banana #3 is on the right.

FIG. 9: DA index of apples preserved using KMnO₄ and a material prepared in accordance with one embodiment of the invention (denoted as “Tec”).

FIG. 10: Photos of apples following 81 days stored in the presence of a material prepared in accordance with one embodiment of the invention (above the dashed line) and 81 days stored under control conditions (below the dashed line).

### DETAILED DESCRIPTION

The present invention broadly relates to a material comprising a metal or metal alloy, wherein the metal or metal alloy has at least one porous metal oxide layer thereon.

In some embodiments the metal is aluminium, zinc or a first or second row transition metal. In other embodiments the metal is aluminium, copper, iron, zinc, manganese, palladium or titanium. In one embodiment the metal is aluminium. The metal alloy may be an aluminium alloy or a zinc alloy. The aluminium alloy may comprise, or consist of, aluminium and one or more of copper, iron, zinc, manganese, palladium, silicon, titanium and unavoidable impurities. The aluminium alloy may comprise at least 80%, or at least 81%, or at least 82%, or at least 83%, or at least 84%, or at least 85%, or at least 86%, or at least 87%, or at least 88%, or at least 89%, or at least 90%, or at least 91%, or at least 92%, or at least 93%, or at least 94%, or at least 95%, or at least 96%, or at least 97%, or at least 98%, or at least 99% aluminium by weight or by mol %. In one embodiment the metal alloy is aluminium foil.

The material may have a thickness between about 5 microns to about 1 mm, or between about 5 microns and about 500 microns, or between about 5 microns and about 400 microns, or between about 5 microns and about 300 microns, or between about 5 microns and about 200 microns, or between about 5 microns and about 100 microns, or between about 5 microns and about 90 microns, or between about 5 microns and about 80 microns, or between about 5 microns and about 70 microns, or between about 5 microns and about 60 microns, or between about 5 microns and about 50 microns, or between about 5 microns and about 40 microns, or between about 5 microns and about 30 microns, or between about 5 microns and about 20 microns, or between about 5 microns and about 15 microns, or between about 7.5 microns and about 12.5 microns.

The metal oxide layer(s) may have a thickness between about 300 nm and about 1 mm, or between about 1 micron and about 100 microns, or between about 1 micron and about 90 microns, or between about 1 micron and about 80 microns, or between about 1 micron and about 70 microns, or between about 1 micron and about 60 microns, or between about 1 micron and about 50 microns, or between about 1 micron and about 40 microns, or between about 1 micron and about 30 microns, or between about 1 micron and about 20 microns, or between about 5 microns and about 15 microns, or about 10 microns.

The metal or metal alloy may have a thickness between about 100 nm and about 50 microns, or between about 500 nm and about 50 microns, or between about 1 micron and about 50 microns, or between about 1 micron and about 40 microns, or between about 1 micron and about 30 microns, or between 1 micron and about 20 microns, or between about 5 microns and about 15 microns or between about 3 microns and about 10 microns.

In some embodiments the metal oxide layer(s) comprise a three-dimensional disordered network of channels in which pores have non-constant diameters. As such, the materials may be both mesoporous and microporous. In some embodiments the pores have non-constant diameters ranging from about 1.5 nm to about 250 nm, or from about 1.5 nm to about 200 nm.

The metal oxide layer(s) may have non-constant pore volumes ranging between about 200 cm³/g and about 600 cm³/g, or between about 250 cm³/g and about 600 cm³/g, or between about 250 cm³/g and about 550 cm³/g, or between about 275 cm³/g and about 500 cm³/g, or between about 300 cm³/g and about 500 cm³/g, or between about 350 cm³/g and about 450 cm³/g, or between about 375 cm³/g and about 425 cm³/g, or about 400 cm³/g.

The metal oxide layer(s) may have a surface area between about 20 m²/g and about 50 m²/g, or between about 20 m²/g and about 48 m²/g, or between about 20 m²/g and about 46 m²/g, or between about 20 m²/g and about 44 m²/g, or between about 20 m²/g and about 42 m²/g, or between about 20 m²/g and about 40 m²/g, or between about 20 m²/g and about 38 m²/g, or between about 20 m²/g and about 36 m²/g, or between about 20 m²/g and about 34 m²/g, or between about 20 m²/g and about 30 m²/g, or between about 22 m²/g and about 28 m²/g, or between about 23 m²/g and about 27 m²/g, or about 26 m²/g.

In some embodiments the material is a flexible sheet material.

In some embodiments the metal or metal alloy may have a metal oxide layer on each side. Where the material comprises a single metal oxide layer only, the material may be attached to a base structure. Examples of base structures include, but are not limited to wood, glass, quartz, silicon, water-proof paper, plastic and cloth. The base structure may be any structure that is not sensitive to the acid used in the anodization process.

Materials in accordance with the invention may be conveniently prepared at low cost in a single anodization step starting with the metal or metal alloy of choice. Throughout the anodization process the voltage is continually varied. Without wishing to be bound by any particular theory the inventor believes that continually varying the voltage throughout the anodization process provides a highly porous oxide layer having a three-dimensional disordered network of channels in which the pores have non-constant diameters. This optimises the porosity and surface area of the resultant material. The surface area of the material may be more than two orders of magnitude larger than known, ordered anodic aluminium oxide, which has a surface area of about 0.1 m²/g.

After the anodization process, metals in the oxide layer are oxidised. For example, Al will become Al₂O₃ or AlₓO_{y}, Fe will become FeO or Fe₂O₃ and Cu will become CuO or Cu₂O.

In some embodiments the voltage is varied throughout the anodization by first increasing the voltage linearly, for example at a rate between about 0.05 V/s and about 0.3 V/s, or at a rate between about 0.1 V/s and about 0.2 V/s, and then applying the voltage in a series of pulses.

The voltage may be linearly increased from 0 V for a period of time between about 10 minutes and about 30 minutes, or between about 10 minutes and about 20 minutes. The voltage may be linearly increased from 0 V up to a voltage between 100 V and 200 V, or up to a voltage between 120 V and 180 V, or up to a voltage between 130 V and 150 V, or up to about 140 V.

The voltage may be applied in a series of pulses for a period of time between about 30 minutes and 150 minutes, or for a period of time between about 50 minutes and 150 minutes, a period of time between about 90 minutes and about 150 minutes, or fora period of time between about 120 minutes and 150 minutes.

The electrolyte may be phosphoric acid, however those skilled in the art will appreciate that other acids, such as for example sulfuric acid, nitric acid and oxalic acid may be used. In some embodiments, mixtures of one or more acids may be used.

Typically the anodization is performed at a temperature between about 0° C. and about 10° C. In some embodiments the anodization is performed at a temperature of about 5° C.

It has been found that by starting with an aluminium alloy (aluminium foil) and adopting the following anodization protocol, one is able to prepare an aluminium-based material having highly porous oxide layers on either side, a surface area of about 26 g/m², pore sizes ranging from 1.5 nm to 200 nm and pore volumes up to about 400 cm³/g.
Phosphoric acid electrolyte (0.3 M) and temperature of 5° C.
linearly increasing the voltage at a rate of about 0.16 V/s from 0 V to 140 V, followed by:
applying a pulsed voltage 140 V/0 V every second; and wherein
the total anodization time is 150 minutes.

Where the anodization is performed on an alloy, it will be appreciated that multiple oxides corresponding to one or more of the constituent metals will be produced. Where the anodization is performed on a pure or highly pure metal, it is possible to introduce oxides of other metals into the metal oxide layer(s) during the anodization process by using a counter electrode corresponding to the metal oxide that is desired to be introduced.

Depending on the intended use of the material it may be desirable to include one or more transition metal oxides in the oxide layer(s), such as for example copper and iron.

The morphology of the structure may be altered by varying one or more of the anodization parameters: voltage, temperature, acid, electrolyte and timeframe.

Where the material is attached to a base structure, prior to performing the anodization it is necessary to attach the metal or metal alloy layer to the base structure.

Materials in accordance with the invention may find use in capturing/adsorbing gases, such as for example ethylene, carbon dioxide and/or oxygen. The material may also find use in preserving products, for example perishable products such as fruit and vegetables, and also in slowing the ripening of fruit.

When used to preserve/slow the ripening of fruit it has been found that it is not necessary to wrap the fruit with the material. The preservation effect may be achieved with substantially less material than that required to wrap each piece of fruit. For example, the preservation effect may be achieved by placing a sheet of the material in a container together with the fruit and sealing the container. Boxes/containers used to transport and store fruit may be provided with the material so as to preserve the fruit while in transit and in storage. The preservative effect has been found to last for up to 10 weeks.

Preservation of fruit with materials in accordance with the invention is significantly more cost effective than alternatives such as refrigeration and refrigeration in combination with a controlled inert atmosphere.

In home and commercial settings the material may be placed in the crisper part of the fridge or in the bottom of a fruit bowl to assist preservation.

Fruits that may be preserved using methods of the invention include, but are not limited to, bananas, apples and cherries.

### EXAMPLES

### Example 1—Preparation of a Material Based on an Aluminium Alloy

Aluminium foil (DSD aluminium, 97% purity) was anodized in an electrochemical cell to form both mesoporous and microporous metal oxide layers on both sides of the foil.

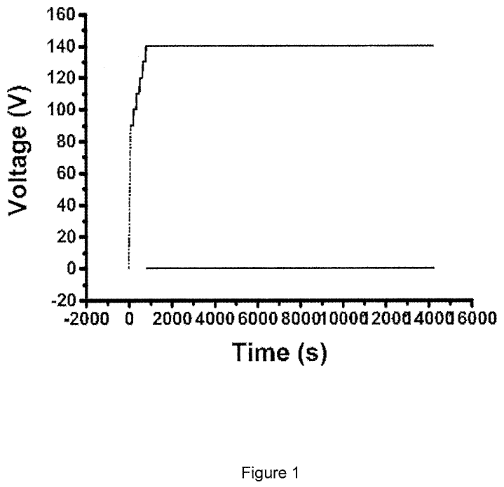

The anodization utilised an aluminium anode and a carbon cathode. The cell comprised a jacketed glass beaker connected to a water chiller (John-mirror). Cooling water was supplied to the jacketed glass beaker to control the temperature of the electrolyte. Phosphoric acid (0.3 M) was used as the electrolyte and the temperature of the electrolyte was maintained at about 5° C. throughout the entire process. The voltage was constantly varied so as to enable production of a three-dimensional disordered network of channels in the metal oxide layers in which the pores have non-constant diameters. The voltage was initially increased linearly at a rate of about 0.16 V/s from 0 V to 140 V, followed by a pulsed voltage repeatedly switching between 140 V and 0 V every second. A graph depicting time versus voltage is shown in FIG. 1. The total anodization time was 9000 s.

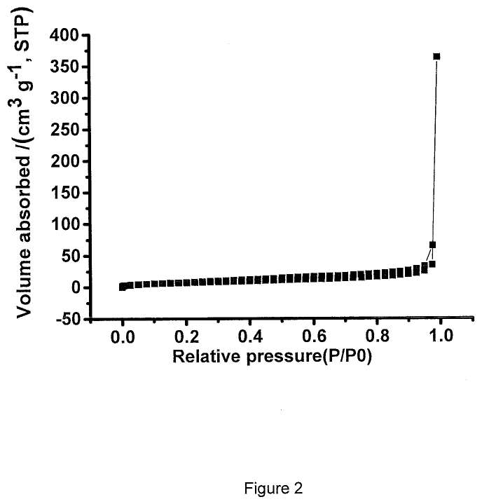

FIG. 2 shows a BET measurement of the prepared material. The surface area was calculated to be 26.4 m²/g.

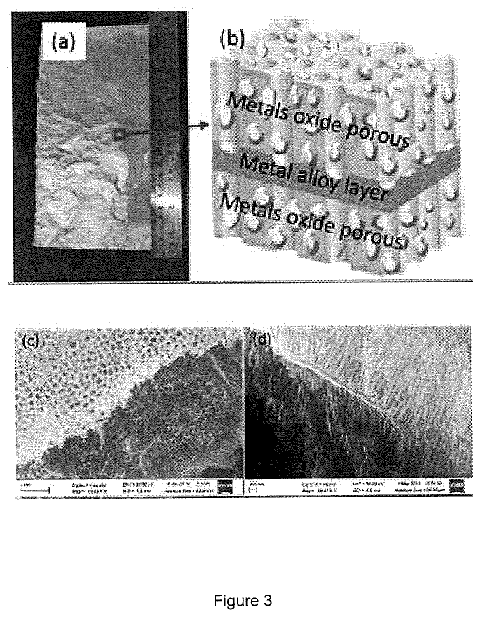

FIG. 3 depicts a photo, structure and SEM images of the prepared material.

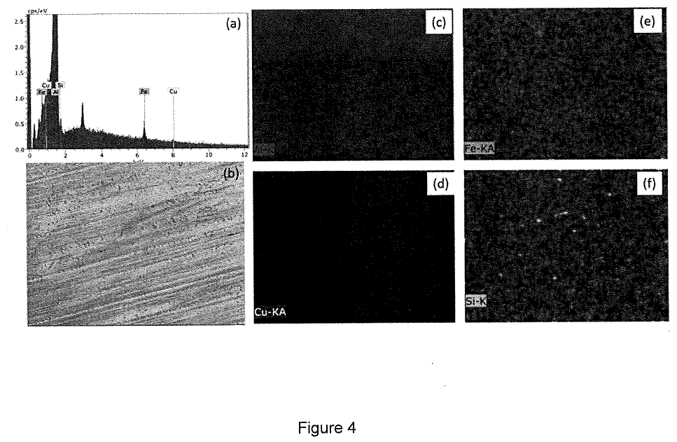

FIG. 4 shows EDS and elemental mapping of the aluminium foil prior to anodization. (a) shows that the aluminium foil used contains aluminium, iron, copper and silicon. All of elements are evenly distributed in the foil. After anodization the surface is transformed into an oxide phase.

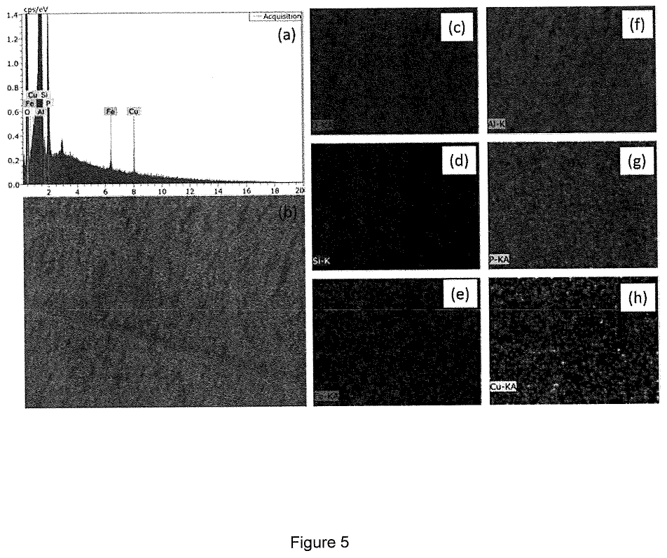

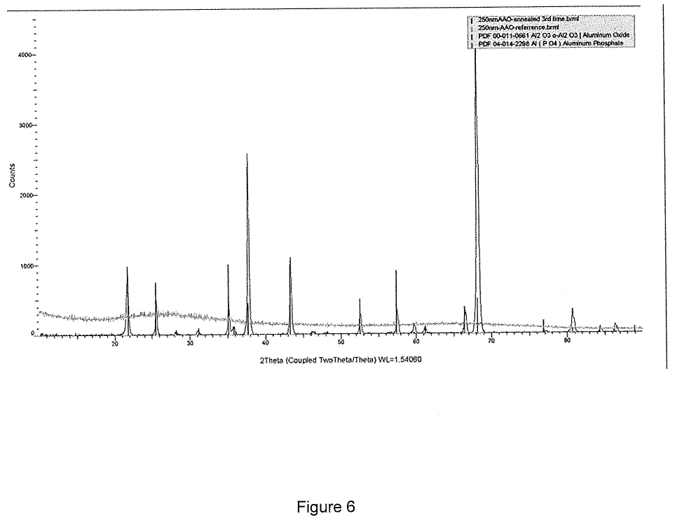

FIG. 5 shows EDS and mapping of the anodized aluminium layer. The oxygen peak is clearly visible in the mapping. Phosphorous also appears in the fabricated structure which presumably comes from the electrolyte. To identify this element a sample of the material prepared was calcinated at 1400° C. for 3 hours. XRD analysis showed that following anodization AlPO₄ was generated (see FIG. 6).

### Example 2—Use of a Material for Preservation of Bananas

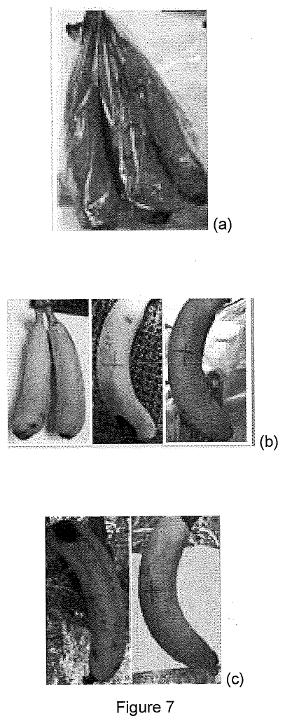

Six green bananas gassed with ethylene and obtained from a single bunch were collected from Flemington market, NSW, Australia (see FIG. 7(a)). After separation banana #1 was selected as the control sample and placed in a glass container (11.5 cm×19 cm×6 cm) and sealed in a zip-lock bag. Nitrogen was applied to purge air from the bag. Banana #2 was subjected to the same conditions as banana #1, except that 0.8 g KMnO₄ powder was added to the bottom of the container. Banana #3 was covered with the material prepared as described above in Example 1. Bananas #1, #2 and #3 were then placed in the dark for the time durations noted below. A DA-meter® was then used to measure the chlorophyll content of each banana. The DA-meter® allows determination of the DA index which ranges from 0, which indicates maximum ripening, to 5 which indicates complete souring.

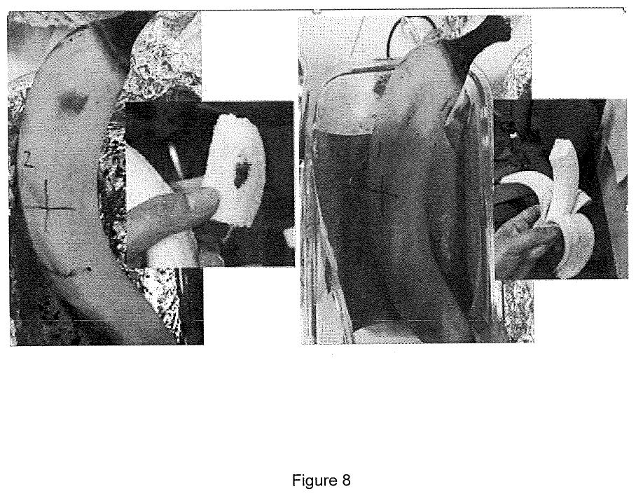

As shown in FIG. 7(b), after 10 days banana #1 became yellow whereas bananas 2# and 3# retained some green colour. After 40 days, bananas 2# and 3# were a mixture of yellow and green (FIG. 7(c)). After 48 days both bananas 2# and 3# became yellow. However, banana 2# possessed a number of black dots and was contaminated inside. Banana 3# maintained a yellow colour and remained uncontaminated inside (see FIG. 8).

This test showed that materials in accordance with the present invention are more effective than KMnO₄ in preserving bananas.

### Example 3—Use of a Material for Preservation of Apples

A material prepared as described above in Example 1 (2 sheets, each 22.5 cm×15.0 cm) was placed in a glass container having the following dimensions: 23 cm×35 cm×6 cm. Four apples were then placed on top of the material. In order to maintain moisture, a slightly wet tissue was also placed in the container. The whole container was covered by aluminium foil and stored in a dark place at room temperature.

Six glass containers having the following dimensions were also provided: 11.5 cm×19 cm×6 cm. Each pair of containers were prepared as follows:
a. Two apples were placed in the containers on top of a material prepared as described above in Example 1. The size of the material was 22.5 cm×15.0 cm;
b. 0.8 g of KMnO₄ powder was applied evenly to the bottom of the containers, a soft tissue was then placed on the top of the KMnO₄ powder and two apples were placed on top of the tissue.
c. Two apples are placed in the container (control).

All of the containers were covered with aluminium foil then sealed in zip-lock bags. The bags were purged with nitrogen to remove air and stored in a dark place at room temperature.

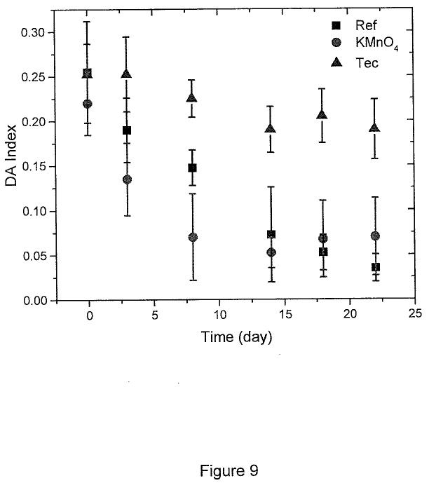

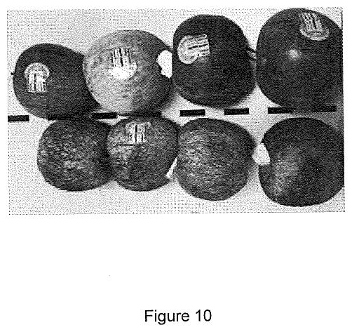

After 24 days a DA-meter® was used to measure the level of chlorophyll in the apples. As shown in FIG. 9, on day 1 the chlorophyll levels of all of the apples are similar, around 0.20-0.25. However, after 24 days the chlorophyll content of apples preserved with the material decreased much more slowly than apples stored under the other conditions. This clearly shows that the ripening speed substantially decreases in the presence of the material. Moreover, after 32 days the control apples were rotten and after day 35 the KMnO₄-preserved apples are also rotten. At 81 days, only apples preserved using the material as described in Example 1 were not rotten (see FIG. 10).

Although the invention has been described with reference to specific embodiments, it will be appreciated by those skilled in the art that the invention may be embodied in many other forms.

1. A material comprising a metal or metal alloy, wherein the metal or metal alloy has at least one porous metal oxide layer thereon.

2. The material of claim 1, which has thickness of about 1 micron to about 1 mm.

3. The material of claim 1 or claim 2, wherein the metal oxide layer(s) have a thickness between about 300 nm to 1 mm.

4. The material of any one of claims 1 to 3, wherein the metal or metal alloy has a thickness of about 100 nm to about 50 microns.

5. The material of any one of claims 1 to 4, wherein the metal oxide layer(s) have a three-dimensional disordered network of channels in which pores have non-constant diameters.

6. The material of claim 5, wherein the pores have non-constant diameters ranging from about 1.5 nm to about 250 nm, or from about 1.5 nm to about 200 nm.

7. The material of any one of claims 1 to 6, wherein the metal oxide layer(s) have non-constant pore volumes ranging from about 200 cm³/g to about 600 cm³/g.

8. The material of any one of claims 1 to 7, wherein the metal oxide layer(s) have a surface area between about 20 m²/g and about 50 m²/g.

9. The material of any one of claims 1 to 8, which is flexible.

10. The material of any one of claims 1 to 9, which is in the form of a sheet.

11. The material of any one of claims 1 to 10, wherein the metal or metal alloy has a metal oxide layer on each side.

12. The material of any one of claims 1 to 11, which is attached to a base structure.

13. The material of claim 12, wherein the base structure is wood, glass, quartz, silicon, water-proof paper, plastic or cloth.

14. The material of any one of claims 1 to 13, wherein the metal is aluminium, copper, iron, zinc, manganese, palladium or titanium.

15. The material of claim 14, wherein the metal is aluminium.

16. The material of any one of claims 1 to 15, wherein the metal alloy is an aluminium alloy or a zinc alloy.

17. The material of claim 16, wherein the metal alloy is an aluminium alloy.

18. The material of claim 16 or claim 17, wherein the aluminium alloy comprises, or consists of, aluminium and one or more of: copper, iron, zinc, manganese, palladium, silicon or titanium.

19. The material of claim 18, wherein the aluminium alloy comprises at least 90%, or at least 95%, or at least 96%, or at least 97%, or at least 98%, or at least 99% Al by weight.

20. The material of any one of claims 17 to 19, wherein the aluminium alloy is aluminium foil.

21. A material comprising a metal or metal alloy, the metal or metal alloy having a porous metal oxide layer on each side, wherein the metal oxide layers have a three-dimensional disordered network of channels in which pores have non-constant diameters.

22. A material comprising an aluminium alloy having a porous oxide layer on each side, wherein the oxide layers have a three-dimensional disordered network of channels in which pores have non-constant diameters ranging from about 1.5 nm to about 250 nm.

23. A material comprising an aluminium alloy having a porous oxide layer on each side, wherein the oxide layers have a three-dimensional disordered network of channels in which pores have non-constant diameters ranging from about 1.5 nm to about 250 nm, and wherein the metal oxide layers have a surface area greater than about 20 m²/g.

24. A material comprising an aluminium alloy having a porous oxide layer on each side, wherein the oxide layers have a three-dimensional disordered network of channels in which pores have non-constant diameters ranging from about 1.5 nm to about 250 nm, and wherein the metal oxide layers have a surface area between about 20 m²/g and about 40 m²/g.

25. A flexible sheet material comprising an aluminium alloy having a porous oxide layer on each side, wherein the oxide layers have a three-dimensional disordered network of channels in which pores have non-constant diameters ranging from about 1.5 nm to about 250 nm, and wherein the metal oxide layers have a surface area between about 20 m²/g and about 40 m²/g.

26. A flexible sheet material comprising an aluminium alloy having a porous oxide layer on each side, wherein the oxide layers have a three-dimensional disordered network of channels in which pores have non-constant diameters ranging from about 1.5 nm to about 250 nm, and wherein the metal oxide layers have a surface area between about 20 m²/g and about 40 m²/g, and wherein the aluminium alloy has a thickness between about 3 and 10 microns.

27. A method for preparing a material as defined in claim 1 comprising anodization of the metal or metal alloy in the presence of an electrolyte, wherein the voltage is varied throughout the anodization.

28. The method of claim 27, wherein the voltage is varied throughout the anodization between about 0 V and about 400 V, or between about 0 V and about 200 V, or between about 0 V and about 180 V, or between about 0 V and about 140 V.

29. The method of claim 27 or claim 28, wherein the voltage is varied throughout the anodization by first increasing the voltage linearly, and then applying the voltage in a series of pulses.

30. The method of claim 29, wherein increasing the voltage linearly involves increasing the voltage at a rate between about 0.05 V/s and about 0.3 V/s, or at a rate between about 0.1 V/s and about 0.2 V/s.

31. The method of claim 29 or claim 30, wherein applying the voltage in a series of pulses involves repeatedly switching the voltage between a voltage between 100 V and 200 V and 0 V each second.

32. The method of any one of claims 29 to 31, wherein the voltage is linearly increased for a period of time between about 10 minutes and about 30 minutes, or between about 10 minutes and about 20 minutes.

33. The method of any one of claims 29 to 32, wherein the voltage is linearly increased from 0 V.

34. The method of claim 33, wherein the voltage is linearly increased from 0 V up to a voltage between 100 V and 200 V, or up to a voltage between 120 V and 180 V, or up to a voltage between 130 V and 150 V, or up to about 140 V.

35. The method of any one of claims 29 to 34, wherein the voltage is applied in a series of pulses for a period of time between about 30 minutes and 150 minutes, or for a period of time between about 50 minutes and 150 minutes, a period of time between about 90 minutes and about 150 minutes, or for a period of time between about 120 minutes and 150 minutes.

36. The method of any one of claims 27 to 35, wherein the electrolyte is phosphoric acid.

37. The method of any one of claims 27 to 36, wherein anodization may be performed at a temperature between about 0° C. and about 10° C., or at a temperature of about 5° C.

38. Use of the material of any one of claims 1 to 26 for adsorbing one or more gases.

39. The material of claim 38, wherein the one or more gases are ethylene, carbon dioxide or oxygen.

40. A method for preserving a product comprising placing the material of any one of claims 1 to 26 in the vicinity of the product.

41. The method of claim 40, comprising placing the product in a container together with the material.

42. The method of claim 40, comprising placing the product in a container together with the material and sealing the container.

43. The method of claim 42, wherein the container is flushed with an inert gas prior to sealing.

44. The method of claim 40, comprising wrapping the product with the material.

45. The method of any one of claims 40 to 44, wherein the product is a perishable product.

46. The method of claim 45, wherein the perishable product is fruit or vegetables.

47. The method of claim 46, wherein the perishable product is fruit.

48. The method of claim 47, wherein the fruit is bananas, apples or cherries.

49. A method for slowing ripening of a fruit product comprising placing the material of any one of claims 1 to 26 in the vicinity of the product.

50. The method may comprise placing the fruit product in a container together with the material.

51. The method may comprise placing the fruit product in a container together with the material and sealing the container.

52. The method of claim 51, wherein the container is flushed with an inert gas prior to sealing.

53. The method of claim 49, comprising wrapping the fruit product with the material.

54. The method of any one of claims 49 to 53, wherein the fruit product is bananas, apples or cherries.

55. Use of a material of any one of claims 1 to 26 for preserving a product.

56. Use of a material of any one of claims 1 to 26 for slowing ripening of a fruit product.

57. A method for purifying water comprising contacting the water with a material of any one of claims 1 to 26.

58. A material when obtained by the method of any one of claims 27 to 37.
